(19) United States
(12) Patent Application Publication
(10) Pub. No.: US 2012/0195413 A1
(43) Pub. Date: Aug. 2, 2012

(54) TELEPHONY SESSION MANAGEMENT FOR DATA SERVICES

(75) Inventor: Kim Quo-That Liu, Santa Clara, CA (US)

(73) Assignee: OPENWAVE SYSTEMS INC., Redwood City, CA (US)

(21) Appl. No.: 13/194,195

(22) Filed: Jul. 29, 2011

Related U.S. Application Data
(60) Provisional application No. 61/369,694, filed on Jul. 31, 2010.

(51) Int. Cl. H04M 11/00

(52) U.S. Cl. 379/93.09

(57) ABSTRACT

Data services are managed within the context of telephony services. Using the telephony services to manage the data services allows for authentication, authorization, and accounting of the data services within the framework of the telecommunication services.

### CROSS-REFERENCE TO RELATED APPLICATIONS

This application claims the benefit of U.S. Provisional Application No. 61/369,694, filed on Jul. 31, 2010, which is incorporated by reference herein in its entirety.

### BACKGROUND

Modern telecommunication services offer a variety of ways to communicate information between users. For example, telecommunication services allow users to communicate with each other via audio (i.e., voice) and/or video communications. Some telecommunication services use protocols to establish a telecommunication session under standard conditions. Each type of telecommunication service may be implemented with a unique signaling protocol. The session initiation protocol (SIP) is one type of telephony signaling protocol. In general, SIP is an application-layer control protocol for managing telecommunication sessions between end users.

Conventional telecommunications systems use an intermediate media server to bridge telephony services (such as a voice call) with data services (such as services accessed through hypertext transfer protocol secure (HTTP(S))). The use of a media server, or other intermediate component, between the telephony and data services increases system cost and complexity. As a specific example, implementations which use a media server are constrained in terms of scalability.

### SUMMARY

Embodiments of telecommunication system are described in which the data services are managed within the context telecommunication services. As one example, SIP can be used to manage HTTP(S)/HTML services within the context of a voice or video call. In some embodiments, using the telecommunication services to manage the data services allows for authentication, authorization, and accounting of the data services within the framework of the telecommunication services. Other embodiments of the system are also described. Embodiments of various system components and various method of operation are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic diagram of one embodiment of a conventional communication system which bridges telephony and data services.

FIG. 2 depicts a schematic diagram of one embodiment of a communication system which uses a telephony signaling protocol to manage data services.

FIG. 3 depicts a schematic diagram of one embodiment of the telephony endpoint of FIG. 2.

FIG. 4 depicts a flow chart diagram of one embodiment of method for operating the telephony endpoint of FIG. 3.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While many embodiments are described herein, at least some of the described embodiments allow data services to be managed within the context telephony services. In some embodiments, using the telephony services to manage the data services allows for authentication, authorization, and accounting of the data services within the framework of the telecommunication services. For example, a user may be transferred from a voice call (telephony service) to a HTTP(S)/HTML-based service (data service), and the user may be automatically authenticated with the data service based on the information for the voice call session. In some embodiments, the telephony services are implemented using voice over internet protocol (VoIP) signaling protocols such as SIP (RFC 3261). Other examples and embodiments are described below.

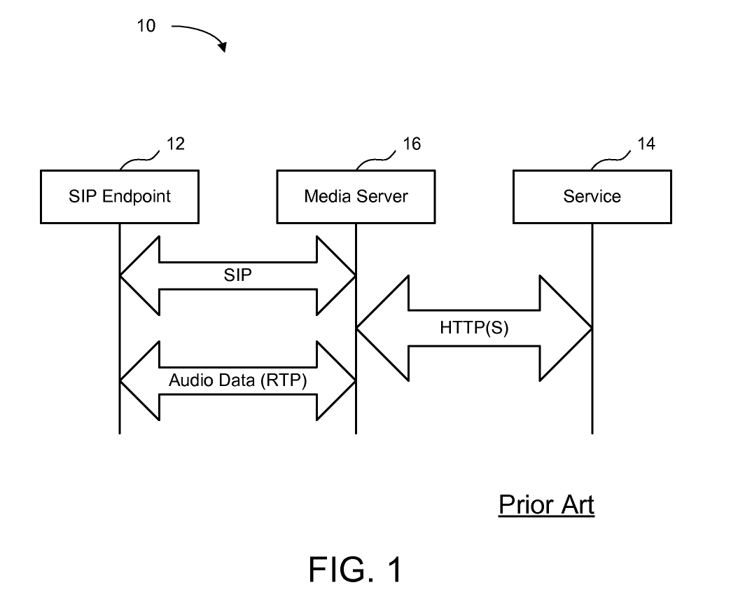

FIG. 1 depicts a schematic diagram of one embodiment of a conventional communication system 10 which bridges telephony and data services. The illustrated communication system 10 includes a telephony endpoint 12 and a data endpoint 14. The telephony endpoint 12 is coupled to the data endpoint 14 via a media server 16.

In general, the telephony endpoint 12 provides telephony services to an end user. Some examples of conventional telephony endpoints include a cellular devices, smart phones, gateways, computers, and so forth. For purposes of this description, the illustrated telephony endpoint 12 is designated as a SIP-enabled endpoint (or simply SIP endpoint) because the telephony endpoint 12 is capable of implementing telephony services using SIP. The telephony endpoint 12 uses SIP to manage telephony communications with other devices. In the illustrated embodiment, the telephony endpoint 12 uses SIP to manage audio data which uses a standardized packet format according to the real-time transport protocol (RTP).

In contrast to the telephony endpoint 12, the data endpoint 14 provides data services other than the audio/video telephony services. As one example, the data endpoint 14 may provide internet data to a user via an internet browser on the user's mobile device. In the illustrated embodiment, the data endpoint 14 uses HTTP(S) in conjunction with hypertext markup language (HTML) for the data communications.

The media server 16 provides an interface between the telephony services and the data services and, more specifically, between the telephony endpoint 12 and the data endpoint 14. Although designated as a media server, the illustrated media server 16 is representative of any type of intermediate component(s) which implement functionality to bridge the telephony services and the data services. While the inclusion of the media server 16 in the conventional communication system 10 provides bridging functionality, the use of the media server 16 also results in specific limitations on the implementation of the conventional communication system 10.

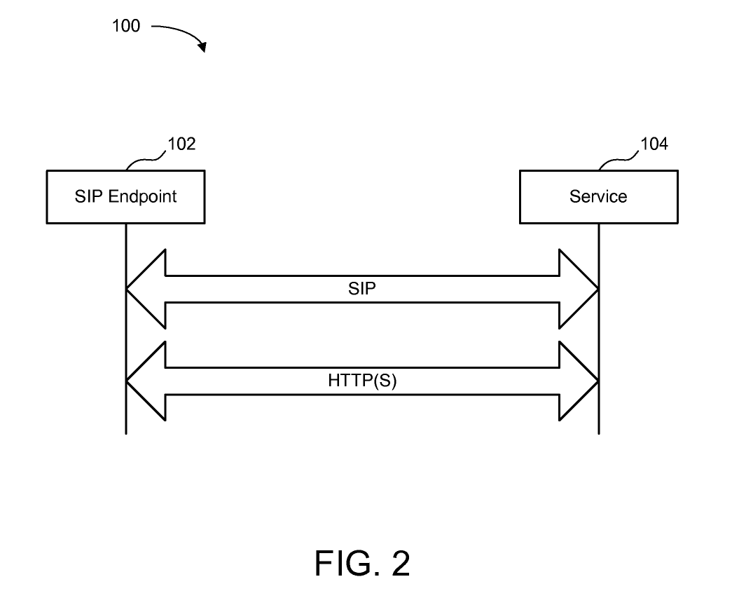

In some embodiments, use of the media server 16 complicates the implementation of the conventional communication system 10 simply because the number of system components is increased. In other embodiments, the media server 16 has limited functionality because the media server 16 has limited ability to transfer communications between the telephony and data domains. In particular, when transferring from the telephony domain to the data domain, the media server 16 is unable to use authorization and authentication schemes from the telephony services for the data services. Consequently, the authorization and authentication information from a telephony session cannot be used for a corresponding data session. Additionally, the media server 16 is unable to transfer from data services back to telephony services because the typical authorization and authentication information for the telephony session is not available from the data services. Similarly, the conventional communication system 10 using the media server 16 is unable to perform accurate billing operation when there is a switch from telephony services to data services, or vice versa. These and other limitations of the conventional communication system 10 are addressed by the communication system shown in FIG. 2 and described below.

FIG. 2 depicts a schematic diagram of one embodiment of a communication system 100 which uses a telephony signaling protocol to manage data services. The illustrated communication system 100 includes a telephony endpoint 102 and a data endpoint 104. Although the communication system 100 is shown and described with certain components and functionality, other embodiments of the communication system may include fewer or more components to implement less or more functionality.

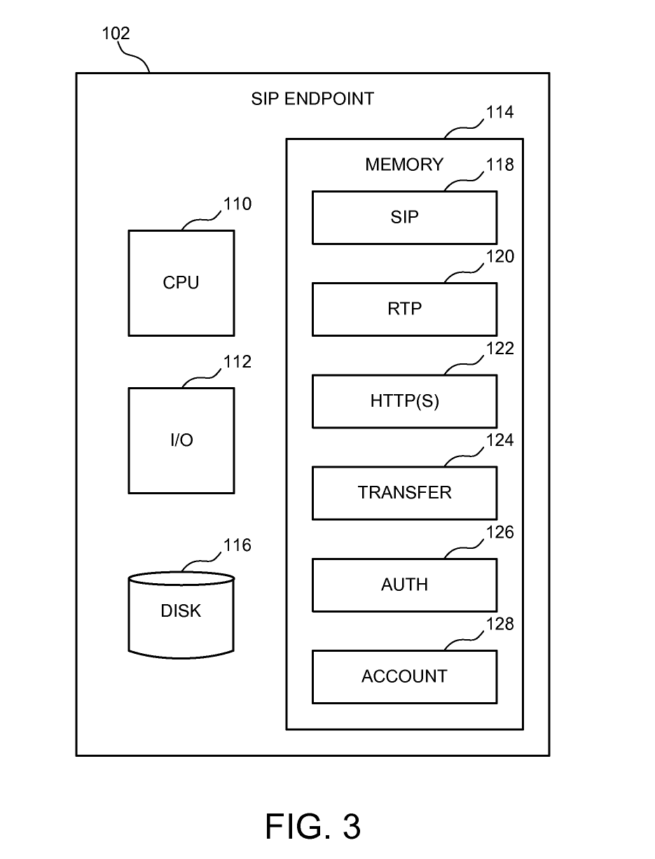

In many ways, the telephony endpoint 102 is similar to the telephony endpoint 12 of FIG. 1, and the data endpoint 104 is similar to the data endpoint 14 of FIG. 1. However, the telephony endpoint 102 of FIG. 2 is different from the telephony endpoint 12 of FIG. 1 in at least one way because the telephony endpoint 102 is capable of managing data communications (e.g., HTTP(S)/HTML services) within the context of the telephony services (e.g., a voice call). One example of the telephony endpoint 102 is shown in FIG. 3 and described in more detail below.

The exclusion of a media server simplifies the creation and deployment of new services by more readily facilitating scalability of the telephony and data services. Additionally, managing data communications within the context of telephony services allows the data services to be managed according to telephony functionality that previously was only available for the telephony services. In one embodiment, communications between two people may be handled with SIP and RTP, while multimedia that is pre-generated, generated, and/or stored within a server can be handled more efficiently with SIP and HTTP/HTTP(S). In this way, embodiments of the communication system 100 allow a communication session to switch between telephony (RTP) and data (HTTP/HTTP(S)) modes within the same session.

For purposes of this description, the illustrated telephony endpoint 102 is designated as a SIP-enabled endpoint (or simply SIP endpoint) because the telephony endpoint 102 is capable of implementing telephony services using SIP. However, in other embodiments, the telephony endpoint 102 may implement one or more other telephony signaling protocols and/or standards instead of, or in addition to, SIP. Some examples of other standards include, but are not limited to, media gateway control protocol (H.248), global system for mobile communications (GSM), and integrated services digital network (ISDN).

In the illustrated embodiment, the telephony endpoint 102 uses SIP to manage audio data which uses a standardized packet format according to the real-time transport protocol (RTP). Although the illustrated embodiment references RTP, other embodiments may use other protocols for the audio data.

In the illustrated embodiment, the data endpoint 104 uses HTTP(S) in conjunction with hypertext markup language (HTML) for the data communications. However, in other embodiment, the data endpoint 104 may use other protocols for the data communications. As one example, the data endpoint 104 may use the extensible messaging and presence protocol (XMPP). Other embodiments may use other protocols or services such as file transfer protocol (FTP), internet message access protocol (IMAP), post office protocol (POP), and simple mail transfer protocol (SMTP).

FIG. 3 depicts a schematic diagram of one embodiment of the telephony endpoint 102 of FIG. 2. The illustrated telephony endpoint 102 includes a processor (CPU) 110, one or more input/output (I/O) devices 112, an electronic data memory device 114, and a disk storage device 116. Although the telephony endpoint 102 is shown and described with certain components and functionality, other embodiments of the telephony endpoint may include fewer or more components to implement less or more functionality.

In one embodiment, the processor 110 implements functionality to make the telephony endpoint 102 operational. The processor 110 may be any type of data processing device or system, including one or more processing cores, integrated memory, and/or other typical components. In one embodiment, the processor 110 executes instructions that are stored on local memory within the processor 110, on the memory device 114, and/or on the storage device 116. Some of the operational instructions that may be executed by the processor 110 are shown within the context of the memory device 114. However, in other embodiments, some or all of the illustrated and described instructions may be stored on another device or stored in a distributed manner on a plurality of devices. Additionally, in some embodiments at least a portion of the described operations may be implemented by other hardware components that are not shown in the simplified illustration of FIG. 3.

In one embodiment, the I/O devices 112 include one or more typical user input devices (e.g., a microphone, keypad, touch screen, etc.) so that a user can input information into the telephony endpoint 102. Similarly, the I/O devices 112 include one or more typical user output devices (e.g., a display screen, light indicators, speaker(s), etc.) so that the telephony endpoint 102 can convey information to the user. The I/O devices 112 also include communication devices (e.g., network interface components) to facilitate telephony and/or data communications between the telephony endpoint 102 and other communications devices such as the data endpoint 104, other telephony endpoints, and other networking nodes and resources within the communication network 100.

In one embodiment, the memory device 114 and the storage device 116 are representative of any type of memory or storage device that can be used to store functional or non-functional data. The memory device 114 and the storage device 116 may be accessed by the processor 110 (or other intermediate data access devices) for typical data operations include read and write operations. In one embodiment, the processor 110 reads instructions from the memory device 114 and/or the storage device 116 in order to execute those instructions and provide general and specific operability to the telephony endpoint 102.

In the illustrated embodiment, the memory device 114 includes software instructions, or program code, that can be accessed and executed by the processor 110. The depicted instructions are associated with functionality for a telephony signaling protocol (SIP) 118, a telephony packeting protocol (RTP) 120, a data signaling protocol (HTTP(S)) 122, domain transferring (TRANSFER) 124, authorization and authentication (AUTH) 126, and accounting (ACCOUNT) 128. Other embodiments may include more or less functionality, or substantially equivalent functionality in the form of different protocols, instructions, and/or procedures.

In one embodiment, the telephony signaling protocol 118 defines a telephony signaling protocol for use when managing telephony and data communications of the telephony endpoint 102. Since both the telephony and the data communications are managed by the same telephony signaling protocol, the telephony endpoint 102 more readily capable of switching between telephony and data communication modes and interacting with telephony and data communication partners.

In one embodiment, the telephony packeting protocol 120 specifies how telephony packets are to be formed when the telephony endpoint 102 is communicating in the telephony signaling mode. In some embodiments, additional layers of telephony protocols may be used in addition to the telephony signaling and packeting protocols described herein.

In one embodiment, the data signaling protocol 122 specifies how data communications are implemented when the telephony endpoint 102 is operating in the data signaling mode. In some embodiments, additional layers of data protocols may be used in addition to the data signaling protocols described herein.

In one embodiment, the domain transferring functionality 124 facilitates switching between telephony and data communications. In a specific example, the domain transferring functionality 124 facilitates the transfer of a traditional voice/video services to new data services by allowing traditional voice/video connections managed by the SIP protocol to be transferred to new data based services. In this way, when in the telephony communications mode, the telephony endpoint 102 uses the telephony signaling protocol to manage the telephony packeting protocol. In contrast, in the data communications mode, the telephony endpoint 102 uses the telephony signaling protocol to manage the data services implemented by the data signaling protocol.

This functionality not only allows for the transfer of voice (or video) calls/sessions to HTTP(S)/HTML based services, but it facilitates the transfer in the return direction from HTTP(S)/HTML based services to voice (or video) calls by maintaining the SIP session state with the associated authentication, authorization, and accounting data. As one example, a user might use a smart phone/PDA to make a SIP-based voice call to a business. The voice call might be transferred to an HTTP(S)/HTML service which displays a HTML page on the user's device which presents the company directory to the user in visual and/or audio format(s). The user may be allowed to perform searches or queries of the company directory through the HTTP(S)/HTML service and choose a party to be connected to. Once a destination party has been selected, the user is transferred from the HTTP(S)/HTML service to a voice call to the destination party while maintaining the existing authentication, authorization, and accounting context provided by the SIP session.

Without the functionality provided by the domain transferring functionality 124, there would be no maintenance of such authentication, authorization, and accounting data across services and domains. For instance, if a user places a call to a local (non-long distance or 1-800) number and, when directed to an HTTP(S)/HTML service for processing, if the resulting destination party (such as tech support) is actually in another country, when the user calls the destination party, the user should not be charged for the call beyond the costs of a local call. However, if the user was to call the destination party directly (if possible) the user would be charged for the long distance call. In order to differentiate between these two situations, and other similar situations, and properly reconcile the billing and authorizations, the session data, as provided by the SIP session, is preserved across the different services (which, in this particular case, are voice/video sessions and HTTP(S)/HTML based services).

In one embodiment, the authorization and authentication functionality 126 facilitate establishing authorization and/or authentication for the telephony communications. When the telephony endpoint 102 switches from the telephony communications mode to the data communications mode, the authorization and/or authentication established for the telephony communications can be used for the authorization and/or authentication within the data communications. Also, when the telephony endpoint 102 switches back from the data communications mode to the telephony communications mode, the authorization and/or authentication can again be used for the telephony communications.

In one embodiment, the authorization and authentication functionality 126 allows the use of telephony style billing and authorization models to manage more complex authorization and authentication schemes for access to HTTP(S)/HTML services. An office interactive voice response (IVR) system may allow the transfer of incoming calls to the ‘main’ number to ‘extensions;’ however, the ‘extensions’ are not directly accessible or visible from outside of the office. Using embodiments described herein, an outside user could be ‘transferred’ to a web page that is not ‘directly’ accessible.

A more complex scenario is one involving multiple, separate entities each with their own security/billing models. As an example, with respect to telephony, a user who subscribes to service from carrier Alpha may make a call that invokes a service on the network of carrier Beta (roaming, 1-900, long distance, etc.). Even though carrier Beta has no records of the specific user, carrier Alpha provides the credentials to allow the user access to the service on behalf of the user, as well as the billing interfaces between the two carriers. By extending these facilities through the use of SIP to HTTP(S)/HTML services, embodiments of this model could allow users of one web service provider Gamma to have access to the services of a second provider Delta, without requiring the user to explicitly sign-up or register with the second provider. The SIP session management provides for an extensible and/or transferable model of authentication, authorization, and accounting for cross-domain access between disparate providers of services.

In one embodiment, the accounting functionality 128 facilitates billing and accounting operations in both the telephony and the data communications modes. In a specific example, the accounting functionality 128 provides for the use of SIP accounting mechanisms to track how long a user is connected and/or viewing a specific HTTP(S)/HTML site via the length of the SIP session. In essence, the ‘session’ with the HTTP(S) server is treated as if it was a ‘phone call’ to the server, with the same accounting mechanisms.

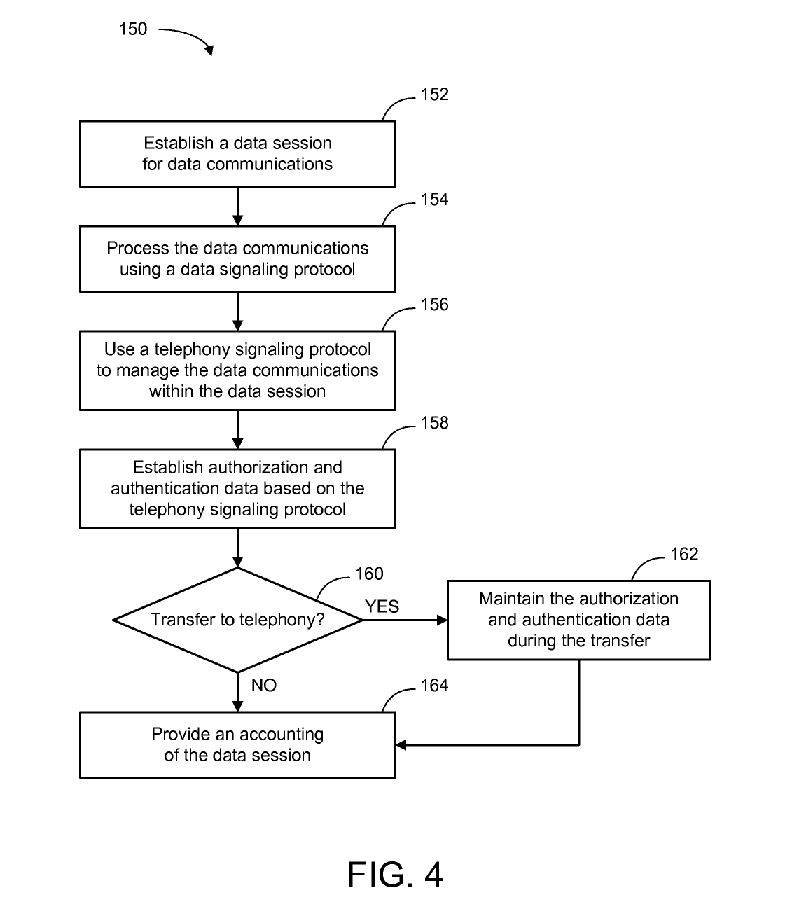

FIG. 4 depicts a flow chart diagram of one embodiment of method for operating the telephony endpoint 102 of FIG. 3. Although the method 150 is described in conjunction with the telephony endpoint 102 of FIG. 3, embodiments of the method 150 may be implemented with other types of telephony endpoints and communication systems.

At 152, the telephony endpoint 102 establishes a data session for data communications. The data session may be newly established or may be established based on a transfer from previous telephony communications. At block 154, the telephony endpoint 102 processed the data communications using a data signaling protocol such as HTTP(S). At block 156, the telephony endpoint 102 uses a telephony signaling protocol such as SIP to manage the data communications within the data session.

At block 158, the telephony endpoint 102 establishes authorization and authentication data based on the telephony signaling protocol. At block 160, the telephony endpoint 160 determines if a transfer should be made from the data session to a telephony session, or from data communications to telephony communications. If the telephony endpoint determines that a transfer should be made, then in the illustrated embodiment the telephony endpoint 102 makes the transfer, or switch, while maintaining the authorization and authentication data that was used during the data session. After the transfer, or switch is made, or if the telephony endpoint 102 determines that a transfer is not initiated, then the telephony endpoint 102 provides an accounting of the data session. The depicted method 150 then ends.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner. Additionally, some of the operations shown in the illustrated method(s), and the order of the illustrated method(s), are merely representative of one embodiment. Actual implementations of the method(s) in commercialized or other device may vary with more or less detail or other operations from the representative embodiments described herein.

Embodiments of the invention described herein make it possible for traditional telephony networks to be subsumed into an all data network. In some embodiments, removing specialized domain bridging devices such as a media server from the communication system simplifies service creation and provisioning.

Embodiments of the invention, or portions thereof, can take the form of an entirely hardware embodiment, an entirely software embodiment (in which the software is stored on and/or executed by hardware components), or an embodiment containing both hardware and software elements. In one embodiment, the invention is implemented in software, which includes but is not limited to firmware, resident software, microcode, etc.

Some embodiments described herein include at least one data processing device coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

Some or all of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform some or all of the operations described herein

Furthermore, embodiments of the invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device. In a specific embodiment, the computer-usable or computer-readable medium is a physical storage medium on which the program code is stored.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A telephony endpoint comprising:
a processor; and
a memory device to store at least a portion of a telephony signaling protocol and a data signaling protocol, wherein the telephony signaling protocol comprises an application layer protocol for multimedia communications, and the data signaling protocol comprises an application layer protocol for other data communications;
wherein the processor is configured to use the telephony signaling protocol to manage a data session connection associated with the data signaling protocol.

2. The telephony endpoint of claim 1, wherein the memory device is further configured to store instructions for domain transfer functionality, wherein the domain transfer functionality is configured to transfer communications from a telephony session to the data session.

3. The telephony endpoint of claim 2, wherein the domain transfer functionality is further configured to transfer communications from the data session back to telephony session.

4. The telephony endpoint of claim 3, wherein the memory device is further configured to store instructions for authorization and authentication functionality, wherein the authorization and authentication functionality is configured to maintain authorization and authentication data across a transfer between the data session and the telephony session.

5. The telephony endpoint of claim 3, wherein the memory device is further configured to store instructions for accounting functionality, wherein the accounting functionality is configured to maintain accounting data across a transfer between the data session and the telephony session.

6. The telephony endpoint of claim 1, wherein the memory device is further configured to store instructions for accounting functionality, wherein the accounting functionality is configured to track a duration of a data session managed by the telephony signaling protocol.

7. The telephony endpoint of claim 1, wherein the telephony signaling protocol comprises session initiation protocol (SIP), and the data signaling protocol comprises hypertext transfer protocol secure (HTTP(S)).

8. The telephony endpoint of claim 1, wherein the processor is further configured to use the telephony signaling protocol to manage a telephony session connection associated with the telephony signaling protocol and a telephony packeting protocol, wherein the telephony packeting protocol comprises real-time transport protocol (RTP).

9. A method comprising:
processing data communications using a data signaling protocol, wherein the data signaling protocol comprises an application layer protocol for the data communications; and
using a telephony signaling protocol to manage a data session for the data communications, wherein the telephony signaling protocol comprises an application layer protocol for multimedia communications.

10. The method of claim 9, further comprising:
establishing authorization and authentication data for a telephony session; and
maintaining the authorization and authentication data during a transition from the telephony session to the data session.

11. The method of claim 10, further comprising maintaining the authorization and authentication data during a transition from the data session back to the telephony session.

12. The method of claim 9, further comprising maintaining accounting data during a transition between the data session and a telephony session.

13. The method of claim 9, further comprising tracking a duration of the data session managed by the telephony signaling protocol.

14. The method of claim 9, wherein the telephony signaling protocol comprises session initiation protocol (SIP), and the data signaling protocol comprises hypertext transfer protocol secure (HTTP(S)).

15. A computer program product comprising a computer readable storage medium with program code stored thereon, wherein the program code, when executed by a processor, causes the computer processor to perform operations for managing a data session, wherein the operations comprise:
processing data communications using a data signaling protocol, wherein the data signaling protocol comprises an application layer protocol for the data communications; and
using a telephony signaling protocol to manage a data session for the data communications, wherein the telephony signaling protocol comprises an application layer protocol for multimedia communications.

16. The computer program product of claim 15, wherein the program code, when executed by the processor, causes the processor to perform further operations comprising:
establishing authorization and authentication data for a telephony session; and
maintaining the authorization and authentication data during a transition from the telephony session to the data session.

17. The computer program product of claim 15, wherein the program code, when executed by the processor, causes the processor to perform further operations comprising maintaining the authorization and authentication data during a transition from the data session back to the telephony session.

18. The computer program product of claim 15, wherein the program code, when executed by the processor, causes the processor to perform further operations comprising maintaining accounting data during a transition between the data session and a telephony session.

19. The computer program product of claim 15, wherein the program code, when executed by the processor, causes the processor to perform further operations comprising tracking a duration of the data session managed by the telephony signaling protocol.

20. The computer program product of claim 15, wherein the telephony signaling protocol comprises session initiation protocol (SIP), and the data signaling protocol comprises hypertext transfer protocol secure (HTTP(S)).
